(19) United States
(12) Patent Application Publication
(10) Pub. No.: US 2003/0189073 A1
(43) Pub. Date: Oct. 9, 2003

(54) Container and containment stabilization system and method

(76) Inventor: Timothy Tianyi Chen, Athens, GA (US)

Correspondence Address: Thomas J. McWilliams, REEDSMITH LLP, 2500 One Liberty Place, 1650 Market Street, Philadelphia, PA, 19103-7301, US

(21) Appl. No.: 10/117,355

(22) Filed: Apr. 5, 2002

(51) Int. Cl. B60R 7/12; B60R 7/14; B60R 9/00

(52) U.S. Cl. 224/400

(57) ABSTRACT

An adhesable sauce cup and system for use in a moving vehicle is disclosed. The adhesable sauce cup includes an open cup portion having an open top portion, side walls, and a lower portion, wherein the lower portion forms on a first side interior to the open cup portion a base, and on a second side exterior to the open cup portion a cup underside, and an adhesable fastener premanently affixed to at least a portion of the cup underside, and removably adhesable to a vehicular surface of the vehicle. The adhesable sauce cup may additionally include a disposable cup, wherein the disposable cup is removably placed within the open top portion of the cup housing, and wherein the sauce is placed within the cup.

### CROSS REFERENCE TO RELATED APPLICATIONS

N/A

### BACKGROUND OF THE INVENTION

1. Field of the Invention

The invention relates to containers, and more specifically to containers that can be temporarily mounted on a surface, and mountable container systems and methods.

2. Description of the Background

Temporarily mountable containers, such as food containers holding for example, sauce in cups, food trays, food or drink in cups, such as regular plastic or polymer cups, such as Styrofoam®, and other containers targeted at the short term stable containment of consumable items, are commonly used by food providers, such as fast food providers. One example is the use of small cups to contain sauces. These sauces may be provided with “to-go” food orders, such as from fast food restaurants. Consumers taking “to-go” orders often do so due to impending, or current, travel in a vehicle, such as an automobile, an airplane, or a train. Sauce cups, when used in a moving vehicle, may prove cumbersome, as spillage, or tipping over, of the sauce cup is a common occurrence.

Thus, a need exists for a container which is easily stabalized, a system, and a method of preventing spillage from, and tipping over of, such containers during travelling.

### SUMMARY OF THE INVENTION

An adhesable container and system for use in a moving vehicle is disclosed. The adhesable container includes an open container portion having an open top portion, side walls, and a lower portion, wherein the lower portion forms on a first side interior to the open container portion a base, and on a second side exterior to the open container portion a container underside, and an adhesable fastener permanently affixed to at least a portion of the container underside, and removably adhesable to a vehicular surface of the vehicle. The adhesable container may be embodied as a sauce cup, or tray, for example, and may additionally include a disposable cup or container, wherein the disposable cup is removably placed within the open top portion of the cup housing, and wherein the sauce is placed within the cup.

Thus, the present invention provides a stabailized container system, and a method of preventing spillage from, and tipping over of, containers during travelling.

### BRIEF DESCRIPTION OF THE DRAWINGS

Understanding of the present invention will be facilitated by consideration of the following detailed description of the present invention taken in conjunction with the accompanying drawings, in which like numerals refer to like parts, and wherein:

FIG. 1 is a schematic diagram illustrating an adhesable sauce cup for use in the present invention; and

FIG. 2 is a schematic diagram illustrating an embodiment of a cup system for use in the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a container and container system.

Those of ordinary skill in the art will recognize that other elements are desirable and/or required in order to implement the present invention. However, because such elements are well known in the art, and because they do not facilitate a better understanding of the present invention, a discussion of such elements is not provided herein.

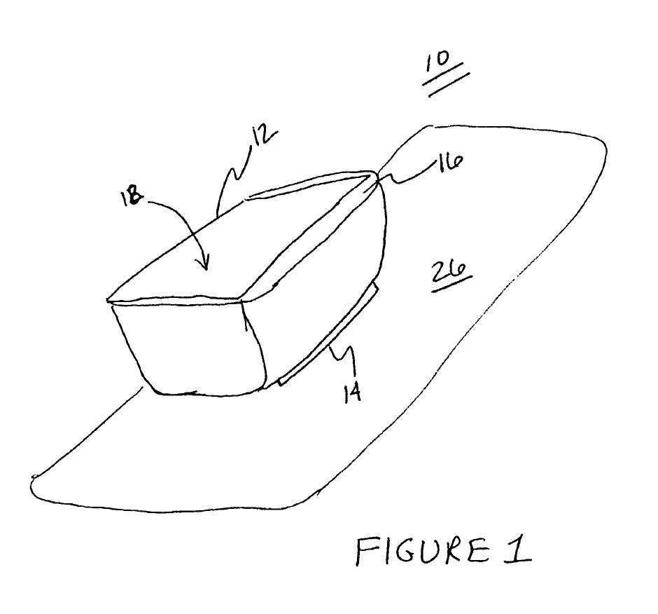

The present invention may be easily understood by providing a detailed exemplary embodiment. One such embodiment is shown in FIG. 1. FIG. 1 is a schematic diagram illustrating an adhesable sauce cup 10 for use in the present invention. The adhesable sauce cup includes a cup portion 12 for containing at least one sauce, and an adhesable fastener 14 on at least an underside of the lower portion of the cup. As used herein, it will be apparent to those skilled in the art that a cup may be, for example, a sauce cup, a food tray, or a plastic cup, for example.

The cup may be any cup known to those skilled in the art, such as a sauce cup used by fast food restaurants for containment of sauces, such as ketchup, barbecue sauce, honey mustard sauce, and the like, for use by travelers with “to-go” orders. The cup may be of any shape, such as circular, or rectangular, and, within the open portion of the cup, may be divided into sections, wherein each section contains a different sauce type. Prior to opening by a consumer, the cup may include a cover, such as a foil cover or the like. The cup may include a lipped portion 16 on the upper portion of the cup, around the outside of the open portion of the cup, which lip portion may be used for the removal of excess sauce on a food item by the user. Food items may be dipped in the cup to obtain sauce thereon, as is known in the art. Food items may include, for example, chicken nuggets, French fries, and the like.

The adhesable fastener 14 is attached to the bottom portion of the cup 12, on the underside of the cup and on the underside opposite the base of the open portion 18 of the cup. The adhesable fastener is preferably permanently attached to the underside of the cup, or permanently attached to a portion thereof. The adhesable fastener operates such that, upon application of a slight pressure to the cup, the bottom portion of the cup is fastened in a location 26 desired by the user, such as to the dashboard, armrest, or tray table of a vehicle, such as an automobile, airplane, or train. The adhesable fastener may include a epoxy or glue that exhibits substantial adhesive properties, but may be completely removable from the vehicle location, such as the dashboard in the above example, by an application of upward pressure by the user. However, the epoxy or glue is preferably such that the slight upward pressure by the user does not remove the adhesion to the bottom portion of the cup of the epoxy or glue. For example, the cup may be made of a plastic or polymer, and the epoxy may be selected such that the adhesion to plastic or polymers is permanent, while the adhesion to, for example, a dashboard material, is non-permanent. Alternatively, the cup may include on its underside a two-part adhesive fastener, such as two halves of a hook and loop fastener, such as Velcro®, wherein one half of the fastener is permanently, or removably, attached to, for example, a dashboard, and the other half of the fastener is permanently fastened to the underside of the lower portion of the cup.

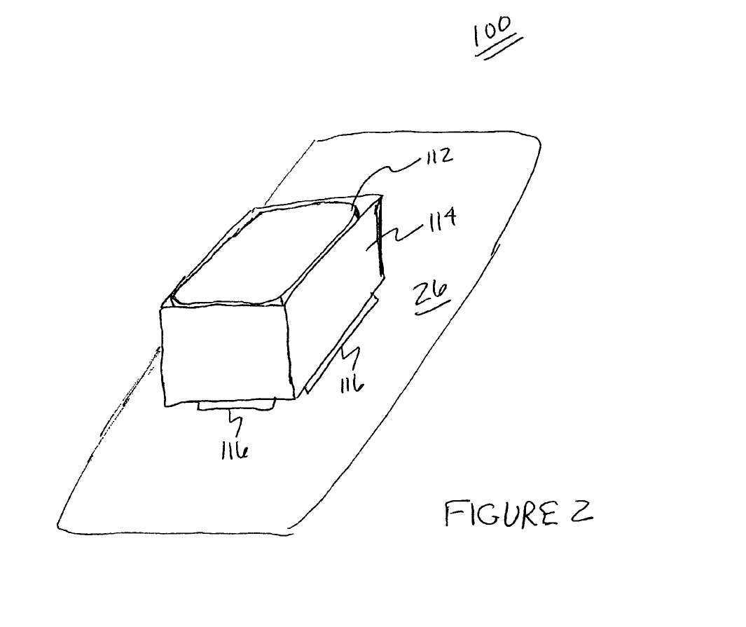

FIG. 2 is a schematic diagram illustrating an embodiment of a cup system 100 for use in the present invention. The cup system of FIG. 2 includes a cup 112, a cup housing 114, and an adhesable fastener 116.

The cup housing of FIG. 2 may be permanently, or removably, attached, such as to the dashboard in the example of FIG. 1, by the adhesable fastener. As was discussed hereinabove with respect to FIG. 1, the adhesable fastener may be a two-part adhesable fastener, wherein one half is fastened to the cup housing on the aforementioned underside, and the other half is fastened, for example, to a vehicle dashboard. Alternatively, the cup housing may include, on the underside thereof, an adhesable fastener in the form of an epoxy or glue that is permanently fastened to the underside of the cup housing, but is removably adhered to, for example, a vehicle dashboard, upon application of a slight downward pressure on the cup housing. Unlike the embodiment in FIG. 1 hereinabove, the adhesive fastener on the underside of the cup housing may permanently fasten the cup housing to the desired location, such as to the vehicle dashboard. The cup housing may be of a variety of shapes, and may accept a variety of cups for placement in the open portion therein. The walls of the outside of the open portion of the cup housing are preferably of sufficient height to contain a variety of cup depths therein, without spillage of sauce from the cup.

The cup of FIG. 2 is preferably placed within the cup housing, and any cup cover is preferably removed by the user to allow access to the sauce therein. Alternatively, disposable cups may be provided, for placement into the cup housing, and for filling with sauce received in packets not easily placed, or not easily accessible when placed, within the cup housing. These disposable cups may be provided by any methodologies known in the art, such as for sale in a sleeve, and sale for storage in a vehicle. Alternatively, disposable cups may be provided by food providers. The user of disposable cups allows for easy access to sauce in a cup within the cup housing, and simultaneously provides for easy clean up by a user of the sauce within the cup, such as by disposing of a used cup.

An embodiment of the present invention may include a food tray, wherein the bottom of the food tray is equipped with an adhesive system as described hereinabove. Such a food tray may hold thereon an entire meal which may be stabilized to prevent spillage of the contents when mounted in any vehicle, such as, for example, a car, truck, plane, train, or boat. Alternately, the food container may be a fast food container made of any material, such as non-limiting examples selected from paper and cardboard containers and polymer containers.

It will be apparent to those skilled in the art that various modifications and variations may be made in the apparatus and process of the present invention without departing from the spirit or scope of the invention. Thus, it is intended that the present invention cover the modification and variations of this invention provided that those modifications and variations come within the scope of the appended claims and the equivalents thereof.

1. An adhesable sauce cup for use in a moving vehicle, comprising:
an open cup portion having an open top portion, side walls, and a lower portion, wherein the lower portion forms on a first side interior to the open cup portion a base, and on a second side exterior to the open cup portion a cup underside; and
an adhesable fastener permanently affixed to at least a portion of the cup underside, and removably adhesable to a surface of the vehicle.

2. The adhesable sauce cup of claim 1, wherein said open cup portion is of a shape selected from the group consisting of circular and rectangular.

3. The adhesable sauce cup of claim 1, wherein said open cup portion includes a cover.

4. The adhesable sauce cup of claim 1, wherein said adhesable fastener includes an epoxy having permanent adhesive properties to a composition of said cup portion, and substantial adhesive properties to the vehicular surface.

5. The adhesable sauce cup of claim 1, further comprising a disposable cup, wherein said disposable cup is removably placed within the open top portion of the cup housing, and wherein the sauce is placed within said cup.

6. An adhesable container for use in a moving vehicle, comprising:
an open container portion having an open top portion, side walls, and a lower portion, wherein the lower portion forms on a first side interior to the open container portion a base, and on a second side exterior to the open container portion a container underside; and
an adhesable fastener permanently affixed to at least a portion of the container underside, and removably adhesable to at least one of an interior and an exterior surface of the vehicle.

7. The adhesable container of claim 6, wherein said adhesable container is selected from the group consisting of a tray, a plate, a plastic cup, a polymer cup, and a fast food container.

8. A method of use of an adhesable container, said method comprising:
mounting said adhesable container to a surface of a vehicle via application of downward pressure to said adhesable container by a user;
consuming the contents of said adhesable container by said user; and
removing said adhesable container via application of upward pressure by said user.
